(19) United States
(12) Patent Application Publication
(10) Pub. No.: US 2007/0059118 A1
(43) Pub. Date: Mar. 15, 2007

(54) Frame structure for auto transport trailer

(76) Inventor: Chun-I Chang, Taichung City (TW)

Correspondence Address: LEONG C LEI, PMB # 1008, 1867 YGNACIO VALLEY ROAD, WALNUT CREEK, CA, 94598, US

(21) Appl. No.: 11/221,729

(22) Filed: Sep. 9, 2005

(51) Int. Cl. B60P 3/08

(52) U.S. Cl. 410/24

(57) ABSTRACT

A frame structure of an auto transport trailer is provided. The frame structure comprises a lower deck, a plurality of supporting rods arranged in parallel along the elongate sides of the lower deck, and a roughly horizontal upper deck supported by the supporting rods. The lower deck has a pair of foldable ramps at its rear end and the upper deck has a pair of lifting ramps hinged to its middle section. On the lower and upper decks, there are ramps that can be tilted at one end so that neighboring cars are somewhat overlapped vertically to reduce the length of the frame structure or to hold more cars.

### BACKGROUND OF THE INVENTION

(a) Technical Field of The Invention

The present invention generally relates to auto transport trailers, and more particularly to a frame structure for an auto transport trailer which provides a degree of overlapping for the cars being hauled so as to reduce the length and thereby improve the transportation safety of the trailer.

(b) Description of the Prior Art

Auto transport trailers are developed to haul multiple cars from one location to another for various purposes such as moving semi-finished cars from one manufacturing facility to another. Auto transport trailers could be roughly categorized as flatbed, open-framed, and enclosed types of trailers. Among them, the open-framed auto transport trailers are usually able to carry more cars than the other two types and various designs and improvements have been applied on the frame structure so as to carry even more cars. Currently, it is not uncommon to find auto transport trailers whose frame structure is able to hold up to eight compact cars at its extreme, with four cars on an upper deck and another four on a lower deck.

Recently, due to the market demand and competition, car manufacturers are making compact cars with longer and larger bodies so as to achieve bigger interior space or more stylish outlook. As such, conventional open-framed auto transport trailers could only hold up to six compact cars which, inevitably, cause an increase of the transportation cost. On the other hand, if the already long frame structure is further lengthened to hold more cars, the transportation safety would be comprised as well.

### SUMMARY OF THE INVENTION

The primary purpose of the present invention is to provide a frame structure for an auto transport trailer which has a shorter length (and, thereby, better transportation safety), or can transport more cars than conventional auto transport trailers.

To achieve the objective, the present invention mainly relies on the use of ramps in the frame structure so that neighboring transported cars are somewhat overlapped vertically so that the frame structure requires only a shorter length or carries more cars than conventional structures. A shorter auto transport trailer also implies a shorter radius of turn and, therefore, a higher degree of transportation safety.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic profile view of the present invention.

FIG. 2 is a schematic view showing how cars are arranged during transportation by the present invention.

FIG. 3 is a perspective view showing the operation of the first ramps of the present invention.

FIGS. 4A & 4B is a perspective view showing the operation of the second ramps of the present invention.

FIGS. 5A & 5B is a perspective view showing the operation of the upper deck's lifting ramps of the present invention.

FIG. 6 is a perspective view showing the operation of the third ramps of the present invention.

FIG. 7 is a perspective view showing the operation of the fourth ramps of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

In the following, detailed description along with the accompanied drawings is given to better explain preferred embodiments of the present invention.

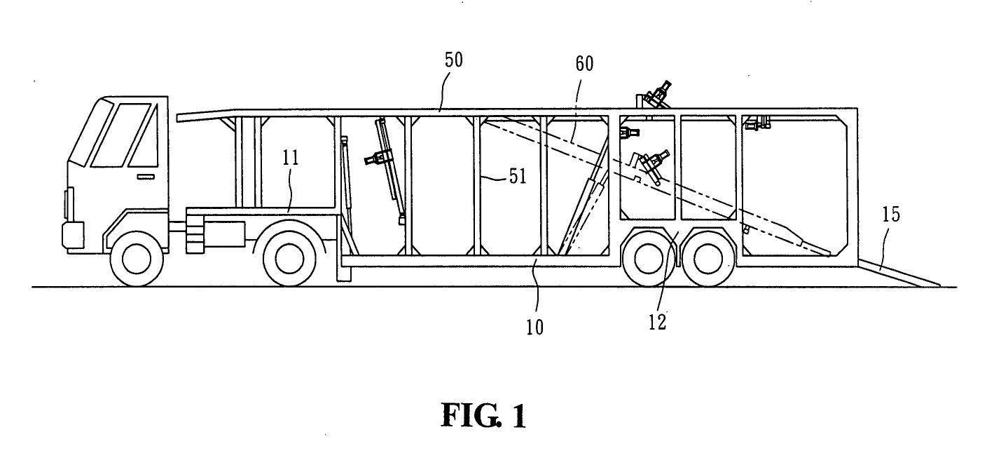

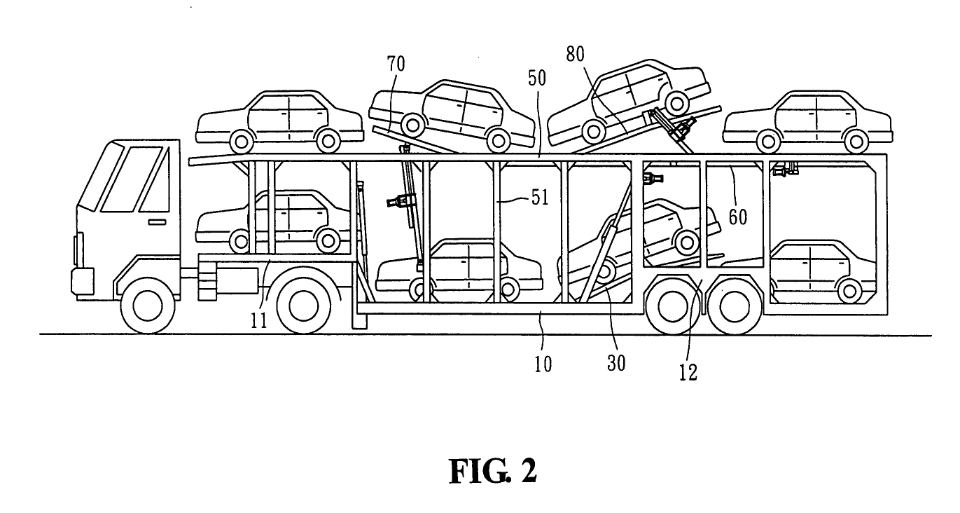

As illustrated in FIGS. 1 and 2, the frame structure according to the present invention mainly contains a lower deck 10, a number of parallel, vertical supporting rods 51 along the elongate sides of the lower deck 10, and a roughly horizontal upper deck 50 supported by the supporting rods 51. For the ease of explanation, the end of the frame structure near the truck is referred to as the front end and the opposite end as the rear end hereinafter. The lower deck 10 has a pair of foldable ramps 15 at the rear end of the lower deck 10 for a transported car to access the frame structure. A pair of lifting ramps 60 is hinged to the middle section of the upper deck 50 which can be tilted and landed on the lower deck 10 for a transported car to access the upper deck 50.

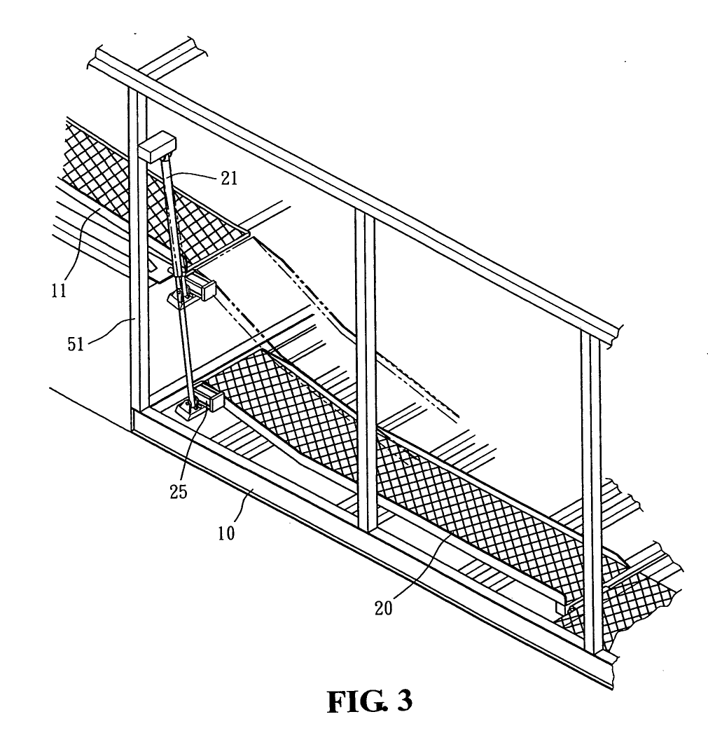

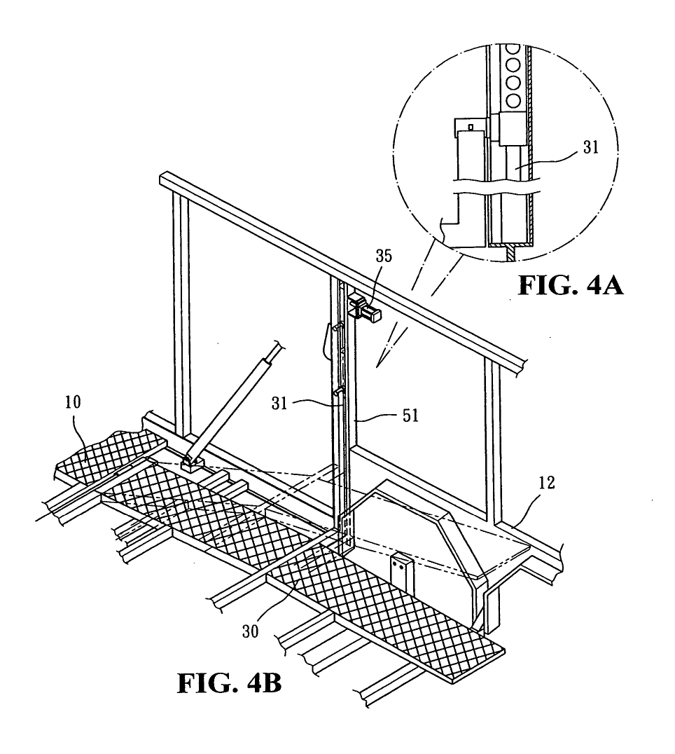

A detailed structure of the present invention is illustrated in FIGS. 3 and 4A & 4B, along with FIGS. 1 and 2. As shown, the lower desk 10 has a raised front deck segment 11 near the truck so as to make room for the front wheels of the trailer. The length of the front deck segment 11 is about the length of a general compact car. The lower deck 10 also has wheel compartments at its middle section so as to make room for the rear wheels of the trailer. Because of the configuration of the front deck segment 11 and the wheel compartments 12, the lower deck 10 has a low gravity center which enhances the stability of the frame structure of the present invention. In the middle section of the lower deck 10, a pair of first ramps 20 and a pair of second ramps 30 are positioned on the lower deck 10 near the front deck segment 11 and the wheel compartments 12 respectively.

The first ramps 20 could be tilted by raising their front ends to match the rear end of front deck segment 11 for a transported car to access the front deck segment 11. The first ramps 20 are lifted by a pair of lifting rods 21 at either side of the first ramp, each of which is configured between a supporting rod 21 adjacent to the rear end of the front deck segment 11 and said lower deck 10, as shown in FIG. 3. A positioning assembly 25 is configured between the front end of a first ramp 20 and a corresponding lifting rod 21, which would lock and position the front end of the first ramp 20 to the rear end of the front deck segment 11 for an improved sturdiness. When the first ramps 20 are lowered to the floor of the lower deck 10 during transportation, the positioning assemblies 25 also help to lock the first ramps 20 to the bottom of the lifting rod 21. On the other hand, another pair of lifting rods 31 is positioned besides a pair of supporting rods 51 near the middle section of the second ramps 30 and the wheel compartments 12 for lifting up the second ramps 30 from their middle section. Similarly, there is a positioning assembly 35 configured for locking and positioning a second ramp 30 for improved sturdiness during transportation.

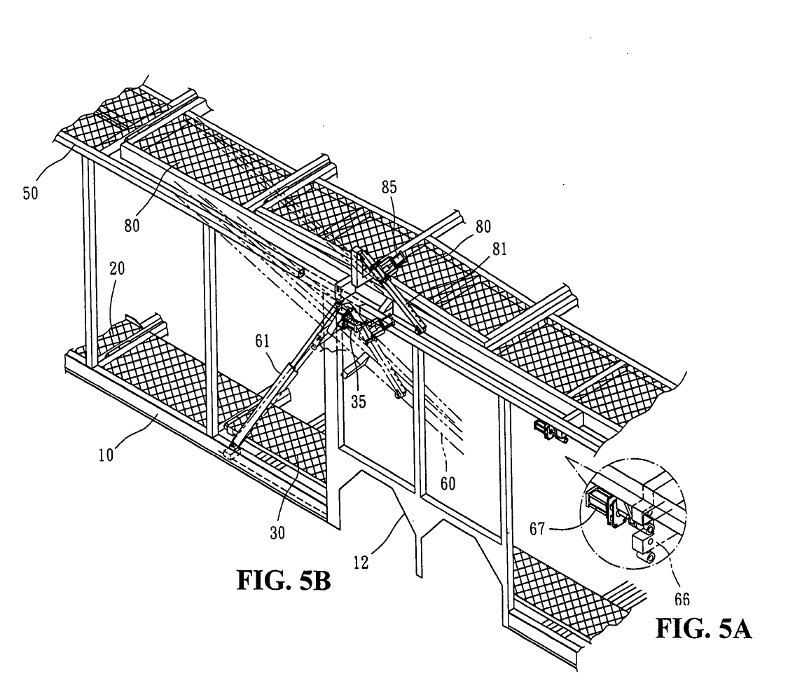

Please refer to both FIGS. 1 and 5A & 5B. The pair of lifting ramps 60 is located at the middle and rear sections of the upper deck 50. Between the lifting ramps 60 and the lower deck 10, there is a pair of lifting rods 61 for lifting and lowering the rear ends of the lifting ramps 60. With the lifting rods 61, the lifting ramps 60 could be lowered to have their rear ends landed on the rear end of the lower deck 10. When the lifting ramps 60 are raised by the lifting rods 61 to the upper deck 50, a pair of notched members 66 at the outer rims near the rear ends of the lifting ramps 60 could be locked to corresponding positioning assemblies 67 at the inner rims of the upper deck 50, so that the lifting ramps 60 could be held steadily to support the transported upper deck 50. Please note that, a pair of third ramps 70 and a pair of fourth ramps 80 are also positioned in the middle section of the upper deck 50 and the middle section of the lifting ramps 60 respectively for tilting the transported cars on the upper deck 50.

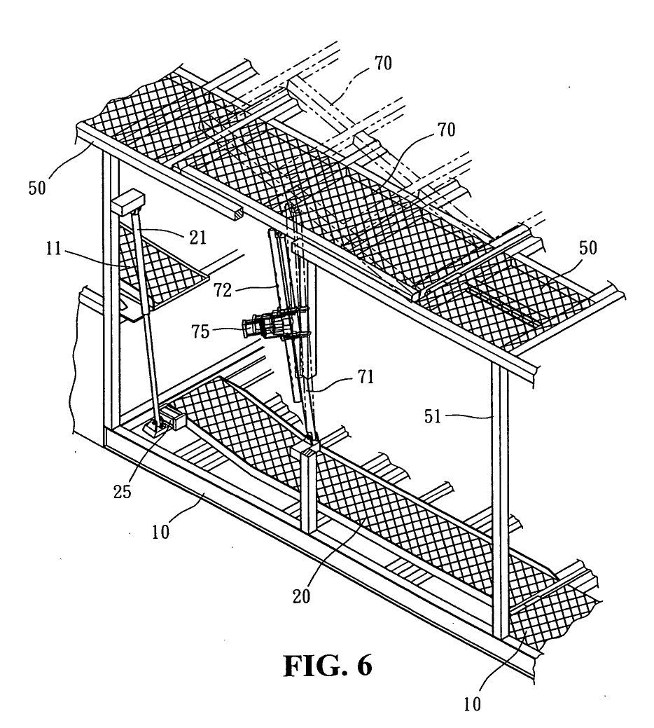

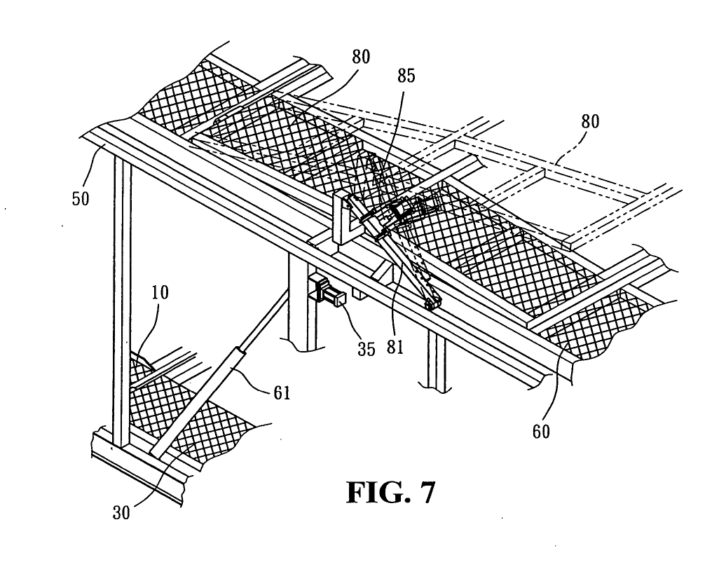

As shown in FIG. 6, the front ends of the third ramps 70 on the upper deck 50 could be raised by a pair of lifting rods 71 positioned between the third ramps 70 and a pair of supporting rods 51. The length of the lifting rods 71 is extended by the use of sliding rods 72 and, when the third ramps 70 have reached a desired angle of tilting, positioning assemblies 75 are used to lock the sliding rods 72 and the lifting rods 71 at their positions. The fourth ramps 80 inside the lifting ramps 60, as illustrated in FIG. 7, could be tilted by raising their rear ends with a pair of lifting rods 81 positioned between the outer rims of the fourth ramps 80 and the lifting ramps 60. Again, positioning assemblies 85 are used to lock the fourth ramps 80 at their positions when there are either tilted or rested on the upper deck 50 for sturdiness during transportation.

Based on the foregoing description, a space-saving and safety enhanced frame structure for an auto transport trailer is thereby achieved.

The loading of the transported cars into the frame structure proceeds as follows. First, as shown in FIG. 1, the lifting ramps 60 are lowered and tilted against the lower deck 10 (as depicted in FIG. 5) and the foldable ramps 15 are unfolded to the ground so that a first car could advance all the way into the front section of the upper deck 50. Then, the front ends of the third ramps 70 are raised by the lifting rods 71 and locked by positioning assemblies 75 (as depicted in FIG. 6) so that a second car could advance onto the third ramps 70 and have part of its front body positioned above the rear end of the first car. A third car then advance onto the lifting ramps 60 until its rear body is above the fourth ramp 80, and subsequently raised by the lifting rods 81 (as depicted in FIG. 7). A fourth car then advance to the rear section of the lifting ramps 60, having its front body somewhat overlapped with the raised rear end of the third car. After the third and fourth cars are at their positions, the lifting ramps 60 are raised by the lifting rods 61 to return to their originally horizontal positions.

Subsequently, the first ramps 20 are raised by the lifting rods 21 and locked at the tilted position by the positioning assemblies 25 to provide access to the front deck segment 11 for a fifth car. After the fifth car is at its position, the first ramps 20 are restored to their original positions and, therefore, a sixth car is able to be parked behind the front deck segment 11. Then, a seventh car enters the lower deck 10 and has its rear body raised by the second ramps 30 and the lifting rods 31. At last, before the foldable ramps 15 are folded, an eighth car is parked at the rear section of the lower deck 10 and has part of its front body somewhat below the raised rear end of the seventh car.

As described above, through the support of the second, third, and fourth ramps, the first and second cars, the third and fourth cars, and the seventh and eighth cars are somewhat overlapped vertically so that a frame structure with a shorter length is achieved (or, more cars could be transported than conventional auto transport trailers), and, thereby, provide a higher degree of transportation safety. In addition, the lifting rods 61, 21, 31, 71, 81 are all accompanied by positioning assemblies 67, 25, 35, 75, and 85 to provide secured positioning and locking, further enhancing the safety of the frame structure.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A frame structure of an auto transport trailer, said auto transport trailer having a front end connected to a truck and allowing cars to access from a rear end, said frame structure comprising a lower deck, a plurality of supporting rods arranged in parallel along the elongate sides of said lower deck, and a roughly horizontal upper deck supported by said plurality of supporting rods, wherein
said lower deck has a pair of foldable ramps at the rear end of said lower deck allowing cars to access said frame structure when said foldable ramps are unfolded to the ground;
said upper deck has a pair of lifting ramps hinged to the middle section of said upper deck allowing cars to access said upper deck when said lifting ramps are lowered and landed on said lower deck;
said lower deck has a raised front deck segment in the front section and wheel compartments in the middle section of said lower deck so as to make room for said auto transport trailer's front and rear wheels respectively;
said lower deck has a pair of first ramps and a pair of second ramps positioned on said lower deck near said front deck segment and the said wheel compartments respectively;
said first ramps are able to be tilted by raising their front ends to match the rear end of said front deck segment by a pair of lifting rods adjacent to the rear end of said front deck segment, each of said lifting rods is configured between a supporting rod and said lower deck, said first ramps are locked to said front deck segment by a pair of positioning assemblies, each of said positioning assemblies is configured between the front end of a first ramp and a corresponding said lifting rod;
said second ramps are able to be tilted by raising their middle sections by another pair lifting rods positioned besides a pair of said supporting rods adjacent to the middle section of the second ramps and said wheel compartments, said second ramps are locked at a tilted position by another pair of positioning assemblies, each of said positioning assemblies is configured on one of said pair of lifting rods respectively;
said pair of lifting ramps is located at the middle and rear sections of said upper deck, said lifting ramps are lifted and lowered by another pair of lifting rods configured between said lower deck and the two outer rims of said lifting ramps, said lifting ramps are able to be lowered to have their rear ends landed on the rear end of said lower deck, a pair of third ramps and a pair of fourth ramps are positioned in the middle section of said upper deck and the middle section of said lifting ramps respectively;
said third ramps are able to have their front ends lifted by another pair of lifting rods positioned between said third ramps and a pair of supporting rods, each of said pair of lifting rods is configured with a sliding rod so as to extend the length of said lifting rod, said lifting rods are configured with positioning assemblies to lock said sliding rods and said lifting rods when said third ramps have reached a desired angle of tilting; and
said fourth ramps are able to have their rear ends lifted by another pair of lifting rods configured between the outer rims of said fourth ramps and said lifting ramps, said lifting rods are configured with positioning assemblies to lock said lifting rods when said fourth ramps have reached a desired angle of tilting.

2. The frame structure of an auto transport trailer according to claim 1, wherein a pair of notched members is configured at the outer rims near the rear ends of said lifting ramps, said pair of notched members is locked to a pair of corresponding positioning assemblies at the inner rims of said upper deck during transportation.
